(19) United States
(12) Patent Application Publication
(10) Pub. No.: US 2007/0182847 A1
(43) Pub. Date: Aug. 9, 2007

(54) PROJECTION DISPLAY APPARATUS

(75) Inventor: Yuichi Ishiwata, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/672,843

(22) Filed: Feb. 8, 2007

(30) Foreign Application Priority Data
Feb. 9, 2006 (JP) 2006-032501

(51) Int. Cl. H04N 9/12; H04N 3/26

(52) U.S. Cl. 348/383; 348/745

(57) ABSTRACT

A projection display apparatus includes a plurality of display units. A control unit controls images generated by the plurality of display units. An optical filter can be inserted to and removed from an optical path. A storage unit stores plural kinds of correction data for each display unit so that correction data can be selected depending on insertion/removal of the optical filter. The control unit selects specific data from the plural kinds of correction data, for each display unit, depending on insertion/removal of the optical filter and controls each display unit based on the selected data.

### BACKGROUND OF THE INVENTION

1. Field of the Invention

The present invention relates to a projection display apparatus (projector).

2. Description of the Related Art

An image, projected on a screen by a projector, includes color unevenness due to various reasons.

For example, a projector is equipped with three liquid crystal panels that operate under the voltage controlled to be a constant value. However, reflectivity or transmissivity of each pixel on the same panel is not the same. Brightness of each pixel is not uniform and varies depending on the position in the panel. Non-uniformity of brightness is different among the three liquid crystal panels, and color unevenness occurs depending on the differences.

The light quantity is relatively low in the peripheral region of a projection region. Color and luminance in a peripheral region are not identical to those in a central region even when the input gradation is the same in a projection region.

As discussed in Japanese Patent No. 03202613, a display region can be divided into plural blocks. In each block, color unevenness can be eliminated by adding a color unevenness correction signal to a V-T corrected video signal. In general, transmissivity of a liquid crystal panel is non-linear compared to the change in amplitude of an input video signal. The V-T correction is employed to obtain linear characteristics by applying inverse correction to the non-linear display characteristics of a liquid crystal panel.

Furthermore, as discussed in Japanese Patent Application Laid-open No. 2001-134252, preparing correction data for spatial representative points and for gradation representative points is effective to reduce a required memory capacity. The interpolation processing can be executed to obtain correction data for every point but the representative points. As a result, the color unevenness correction can be effectively performed while the memory requirement is reduced.

In the use of a projector, contrary requests may arise depending on the purpose of use. For example, when a user is watching a movie, the user may prefer accurate color reproducibility (or clear gradation of black color) rather than brightness of a projection image.

On the other hand, when projection of characters (text) and graphics is required for presentation, a user may prefer brightness rather than accurate color reproducibility.

The former request (i.e., color reproducibility-oriented request) can be satisfied by adding an optical filter that is placed perpendicularly to a projection optical path. However, the optical filter reduces the brightness and therefore using an optical filter is not preferable for the latter request (i.e., brightness-oriented request).

To satisfy the aforementioned contrary requests, a projector can include a mechanism for switching insertion/removal state of a filter to selectively intensify the brightness or color reproducibility.

Additionally, color adjustment gamma correction data can be changed in accordance with insertion/removal of a filter. The mechanism for switching insertion/removal of a filter can be controlled by a user with a remote control or an operation panel.

In the present disclosure, selecting the action state of a filter between an inserted state and a removed state and changing the color adjustment gamma correction data according to the use of a filter is referred to as “image mode selection.”

When a user can select an image mode according to preference or purpose, or projection environment, usability of a projector can be improved.

FIG. 1 illustrates one example of an initialization sequence performed in a filter-equipped projector immediately after a power source of the projector is turned on, including a color unevenness correction control, a filter insertion/removal control, and settings of color adjustment gamma correction data, which are dependent on a selected image mode.

After initialization processing starts (refer to step S20), a control circuit (e.g., central processing unit (CPU)) of the projector executes initialization processing 1 to set initial values for a filter control, a color unevenness correction control, and a color adjustment gamma control. Furthermore, the control circuit sets the image mode to an initial value (refer to step S21).

In step S22, the control circuit checks a startup state of the filter and determines whether switching of the filter insertion/removal state is required.

If switching of the filter insertion/removal state is required for the image mode set as an initial value (YES in step S22), the control circuit executes the filter insertion/removal control in step S23.

In step S24, the control circuit reads color unevenness correction data. In step S25, the control circuit reads color adjustment gamma correction data corresponding to the image mode set as an initial value.

In step S26, the control circuit executes initialization processing 2 (initialization processing for an auto focus circuit or others besides the processing 1). In step S27, the control circuit terminates the initialization processing.

FIG. 2 is a flowchart illustrating a conventional image mode change sequence. A user operates a remote control or an operation panel to change the image mode.

In step S30, the control circuit starts image mode change processing in response to an image mode change instructed by a user.

In step S31, the control circuit executes image mode change processing 1 (including action settings for a fan and a lamp). In step S32, with reference to the present state of the filter, the control circuit determines whether switching of the filter insertion/removal state is required.

If switching of the filter insertion/removal state is required (YES in Step S32), the control circuit executes the filter insertion/removal control in step S33. Then, in step S34, the control circuit changes color adjustment gamma correction data corresponding to each image mode. In step S35, the control circuit executes other image mode change processing (i.e., image mode change processing 2). In step S36, the control circuit terminates the image mode change processing.

According to the above-described conventional method, color unevenness correction data are read in the initialization processing and not changed even if the mode is later changed.

In a liquid crystal panel, the state of color unevenness changes depending on spectral characteristics of illumination light. The spectral characteristics of illumination light can be changed by adding (inserting) an optical filter to the optical path according to the image mode.

The control circuit of the afore-mentioned projector reads color unevenness correction data from a storage device in response to activation of the projector and executes color unevenness correction of a projection image.

However, the state of color unevenness changes if the filter insertion/removal state changes. Therefore, if the color unevenness correction is optimized for a projector not using a filter, obtained color unevenness correction data are not appropriate when the projector uses the filter.

Setting intermediate values for balancing correction effects may be unable to obtain expected effects in both cases.

### SUMMARY OF THE INVENTION

Exemplary embodiments of the present invention are directed to a projection display apparatus capable of appropriately executing color unevenness correction irrespective of the insertion/removal control of a filter.

According to an aspect of the present invention, a projection display apparatus includes a plurality of display units, a control unit, an optical filter and a storage unit. The control unit controls images generated by the plurality of display units. The optical filter can be inserted to and removed from an optical path. The storage unit stores plural kinds of correction data for each display unit so that correction data can be selected depending on insertion/removal of the optical filter. The control unit selects specific data from the plural kinds of correction data, for each display unit, depending on insertion/removal of the optical filter and controls each display unit based on the selected data.

According to another aspect of the present invention, a projection display apparatus includes a plurality of display units. A control unit controls images generated by the plurality of display units. A storage unit stores plural kinds of color unevenness correction data for each display unit so that correction data can be selected depending on a display mode. The control unit selects specific data from the plural kinds of correction data, for each display unit, depending on the display mode and controls each display unit based on the selected data.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a flowchart illustrating a conventional initialization sequence.

FIG. 2 is a flowchart illustrating a conventional image mode change sequence.

FIG. 3 is a circuit block diagram illustrating an exemplary projector.

FIG. 4 is an illustration of color unevenness correction data.

FIG. 5 is a flowchart illustrating an initialization sequence according to an exemplary embodiment.

FIG. 6 is a flowchart illustrating an image mode change sequence according to an exemplary embodiment.

FIG. 7 is a graph illustrating comparison of a gradation range in a filter inserted state and a gradation range in a filter removed state.

FIG. 8 is a graph illustrating a method for setting gradation representative points without considering a gradation range to be used.

FIG. 9 is a graph illustrating a method for setting gradation representative points considering a gradation range to be used.

### DETAILED DESCRIPTION OF THE EMBODIMENTS

The following description of exemplary embodiments is merely illustrative in nature and is in no way intended to limit the invention, its application, or uses.

Processes, techniques, apparatus, and methods as known by one of ordinary skill in the art may not be discussed in detail but are intended to be part of the enabling description where appropriate.

For example, certain circuitry for image processing, data processing, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is described with reference to one figure, it may not be discussed for following figures.

Exemplary embodiments will be described in detail below with reference to the drawings.

### First Exemplary Embodiment

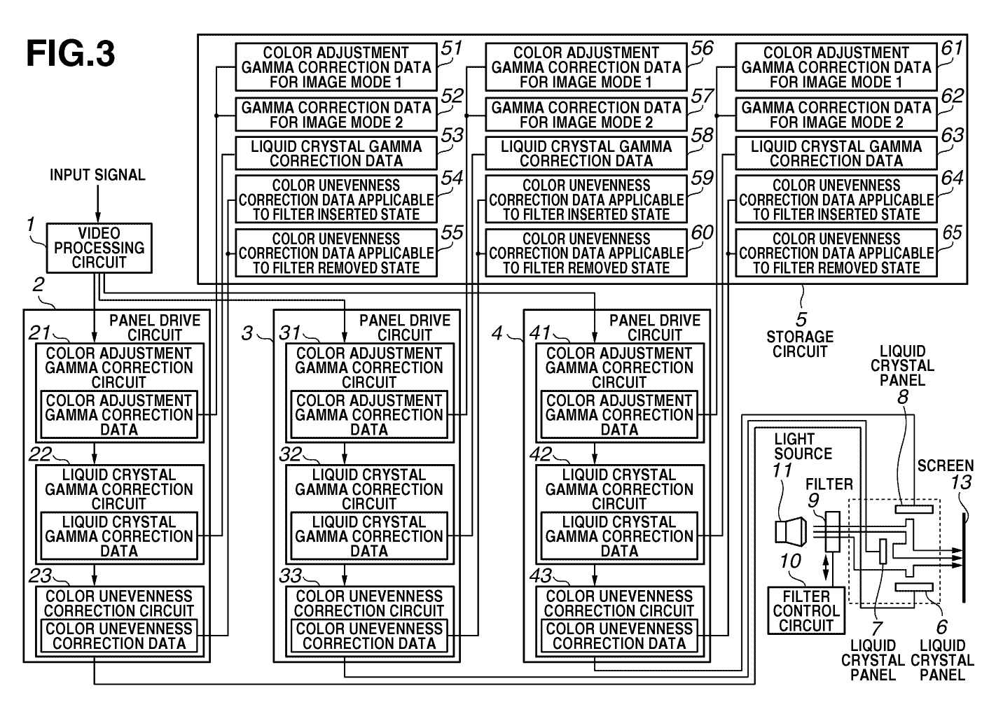

FIG. 3 is a circuit block diagram illustrating a projection display apparatus (projector) according to a first exemplary embodiment.

The projector of the present exemplary embodiment includes a plurality of reflective liquid crystal elements (display units). The display units of the projector are not limited to the reflective type and accordingly can be transmissive liquid crystal elements.

A microcomputer (not shown) can control a video processing circuit 1, plural panel drive circuits 2, 3, and 4, a storage circuit 5, and a filter control circuit 10. The microcomputer includes a central processing unit (CPU), a read only memory (ROM), and a random access memory (RAM).

The CPU executes calculations and various controls for the projector. The RAM functions as a main memory or a work area of the CPU. The ROM stores action processing procedures of the CPU as well as basic software (OS) (i.e., system program) for executing controls of the projector and information required in system operations.

The CPU corresponds to a control unit configured to control an image generated from each display unit. The storage circuit 5 corresponds to a storage unit configured to store various correction data, and can be ROM or a hard disk drive (HDD) or other storage medium.

A light source 11 is, for example, a high-pressure mercury lamp or an incandescent light source (e.g., a halogen lamp), or a semiconductor light source (e.g., LED).

The light emitted from the light source 11, when passing through an optical system (e.g., an illumination system, a color separating/combining system, etc.) including a lens and a prism, can be separated into RGB color beams which respectively enter into corresponding panels 6, 7, and 8.

The liquid crystal panels 6, 7, and 8 reflect incident beams. The panel drive circuits 2, 3, and 4 can control the reflectivity of respective liquid crystal panels 6, 7, and 8.

The RGB color beams of the image light, after reflecting on the liquid crystal panels 6, 7, and 8, are recombined in the optical system (not shown). Then, the image light is projected on a screen 13 by a projection lens (not shown).

An optical filter 9 can change spectral characteristics of light emitted from the light source 11. The filter control circuit 10 controls insertion/removal of the optical filter 9 that can be placed perpendicularly to an optical path extending from the light source 11 to the liquid crystal panels 6, 7, and 8.

The insertion/removal control of the filter 9 is simply feasible according to user's preference. However, in the present exemplary embodiment, insertion/removal of the filter 9 is controlled based on the image mode selected by a user.

The video processing circuit 1 receives a video signal and, if the input signal is an analog signal, performs analog-to-digital (A/D) conversion processing.

The video processing circuit 1 applies various processing to the input video signal, including scale conversion for adjusting an input signal resolution to the panel resolution, various color processing, and trapezoidal distortion correction (keystone correction) processing peculiar to a projector. The input video signal, having been subjected to the above-described processing, is separated into RGB color signals and supplied to the panel drive circuits 2, 3, and 4 of respective colors.

The panel drive circuits 2, 3, and 4 include color adjustment gamma correction circuits 21, 31, and 41. The color adjustment gamma correction circuits 21, 31, and 41, each including a lookup table determining a relationship between an input gradation and an output gradation, can execute conversion of each color signal and output the converted signal to succeeding circuits (i.e., liquid crystal gamma correction circuits 22, 32, and 42 in FIG. 3).

In this case, converting the color adjustment gamma correction data of respective colors so as to change the balance of respective colors determines the chromaticity of an input signal.

The storage circuit 5 stores color adjustment gamma correction data prepared for each image mode. When a user selects image mode 1, the storage circuit 5 sends color adjustment gamma correction data 51, 56, and 61 corresponding to the image mode 1 to the color adjustment gamma correction circuits 21, 31, and 41, respectively.

When a user selects image mode 2, the storage circuit 5 sends color adjustment gamma correction data 52, 57, and 62 to the color adjustment gamma correction circuit 21, 31, and 41, respectively.

The liquid crystal gamma correction circuits 22, 32, and 42 execute inverse correction of liquid crystal voltage-luminance (or voltage-reflectivity, if the panel type is a reflective panel) characteristics, with reference to lookup tables (liquid crystal gamma correction data 53, 58, and 63). Color unevenness correction circuits 23, 33, and 43 receive the inverse corrected signals supplied from the liquid crystal gamma correction circuits 22, 32, and 42, respectively.

Thus, a corrected drive voltage is applied to each pixel of the liquid crystal panels 6, 7, and 8.

The color unevenness correction circuits 23, 33, and 43 divide a display screen into two or more blocks and correct the signals supplied from the liquid crystal gamma correction circuits 22, 32, and 42 so that an average luminance value or a central luminance value in each block becomes uniform.

Color unevenness correction values can be obtained in the following manner.

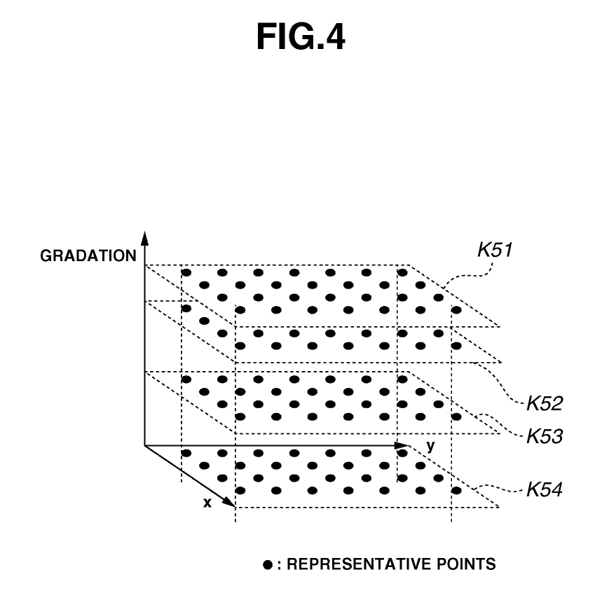

First, as shown in FIG. 4, the microcomputer selects representative gradations (K51, K52, K53, and K54). Then, the microcomputer determines representative points for the display region of each gradation (K51, K52, K53, or K54). For example, the representative points are discrete points equally spaced at constant intervals in both the horizontal direction “x” and the vertical direction “y”.

Then, the microcomputer causes the storage circuit 5 to store correction values at representative points of a selected representative gradation as color unevenness correction data 54, 59, and 64.

If the storage circuit 5 stores all correction values of every input gradation for each pixel in the display region, a large-scale storage capacity will be required. In this respect, the present exemplary embodiment stores only correction values of representative points and accordingly a required storage capacity is small.

In the present exemplary embodiment, the storage circuit 5 stores two kinds of correction data, i.e., color unevenness correction data 54, 59, and 64 applicable to representative points of each representative gradation when the filter is inserted, and color unevenness correction data 55, 60, and 65 applicable when the filter is removed.

The microcomputer can obtain a correction value of every actual input signal by executing interpolation calculation, such as linear approximation, based on the correction data of representative points. The microcomputer can calculate a correction value in a later-described initialization sequence.

In the actual drive control of the liquid crystal panels 6, 7, and 8, each of the color unevenness correction circuits 23, 33, and 43 adds a correction value to an input signal and outputs a corrected signal. Thus, the state of color unevenness can be corrected if the color unevenness occurs due to the difference of position in a display region and the input gradation.

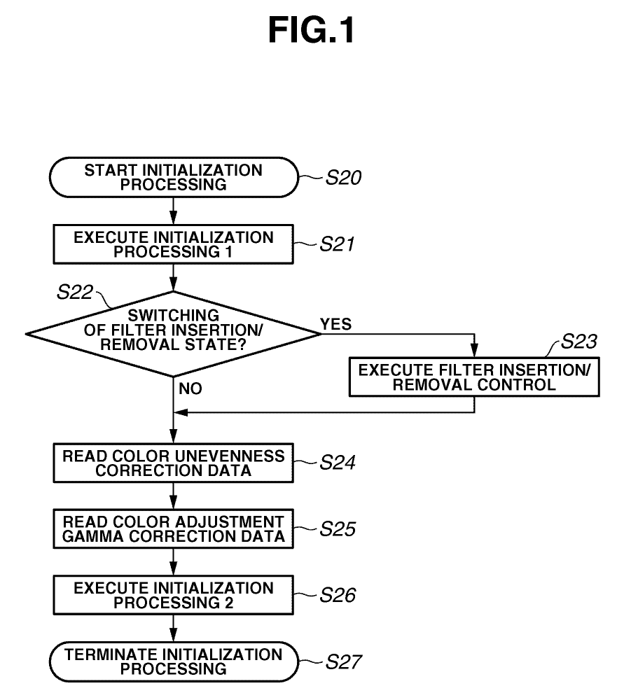

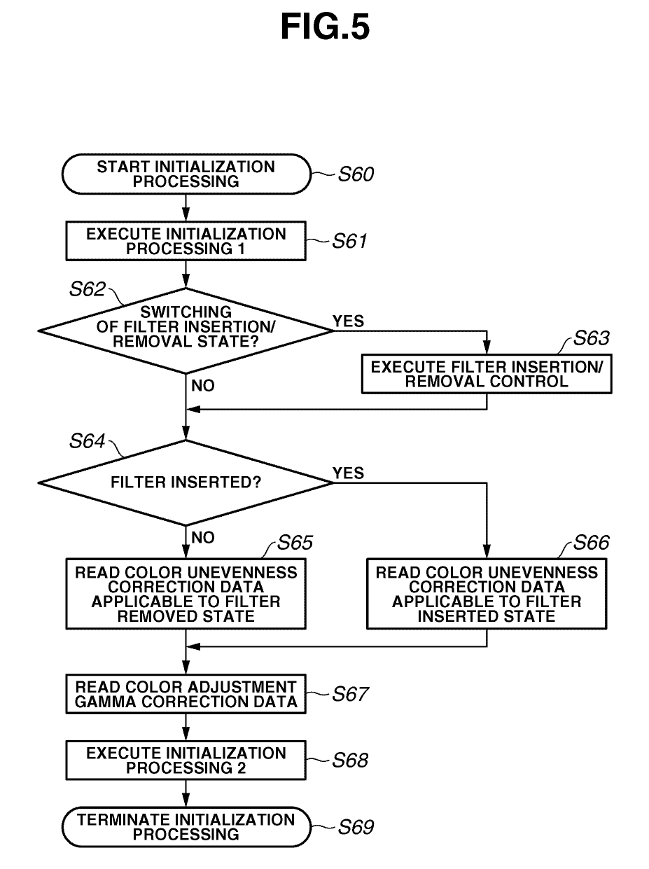

FIG. 5 illustrates an initialization sequence performed when the filter control is dependent on the image mode. Processing of steps S60 through S63 is similar to the processing of steps S20 through S23 of FIG. 1 and will not be described below.

In step S64, the microcomputer determines whether the filter is in an inserted state. If the filter is not inserted (NO in step S64), the microcomputer reads color unevenness correction data 55, 60, and 65 applicable to a filter removed state in step S65. If the filter is inserted (YES in step S64), the microcomputer reads color unevenness correction data 54, 59, and 64 applicable to a filter inserted state in step S66.

In steps S65 and S66, the microcomputer can execute interpolation calculation for obtaining correction data if desirable. In step S67, the microcomputer reads color adjustment gamma correction data corresponding to the selected image mode.

Processing of steps S68 and 69 is similar to the processing of steps S26 and S27 shown in FIG. 1 and will not be described below.

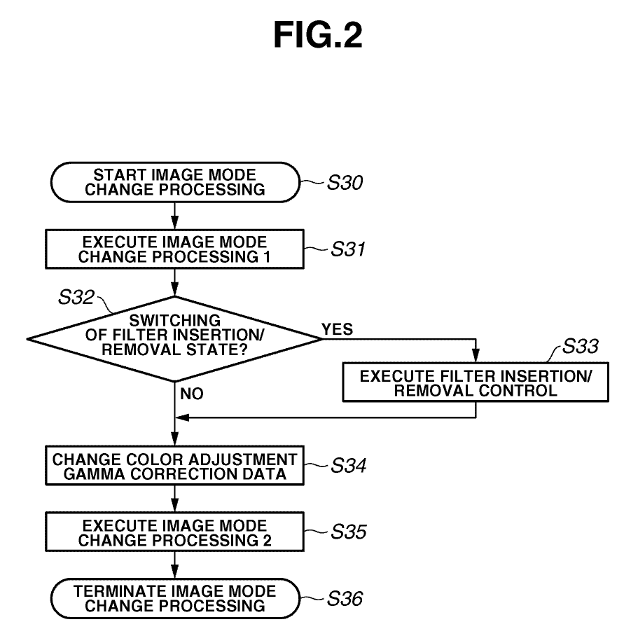

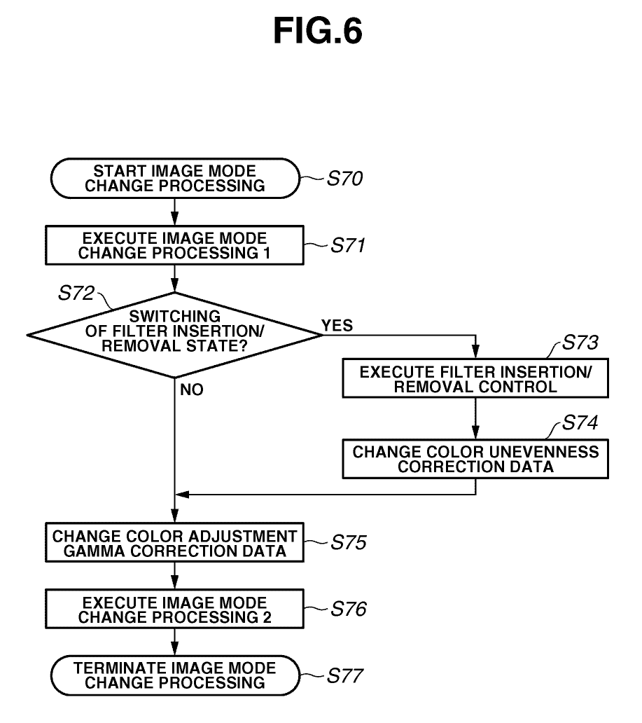

FIG. 6 illustrates an image mode change sequence performed when the filter control is dependent on the image mode. Processing of steps S70 through S73 is similar to the processing of steps S30 through S33 of FIG. 2 and will not be described below.

If switching of the filter insertion/removal state is required, the microcomputer changes the color unevenness correction data in step S74. Processing of steps S75 through S77 is similar to the processing of steps S34 through S36 of FIG. 2 and will not be described below.

As described above, the present embodiment can perform the processing for switching the color unevenness correction data 54, 59, and 64 applicable to a filter inserted state and the color unevenness correction data 55, 60, and 65 applicable to a filter removed state depending on the action state of the filter.

Thus, the present embodiment can optimize the color unevenness correction control regardless of the action state of a filter.

### Second Exemplary Embodiment

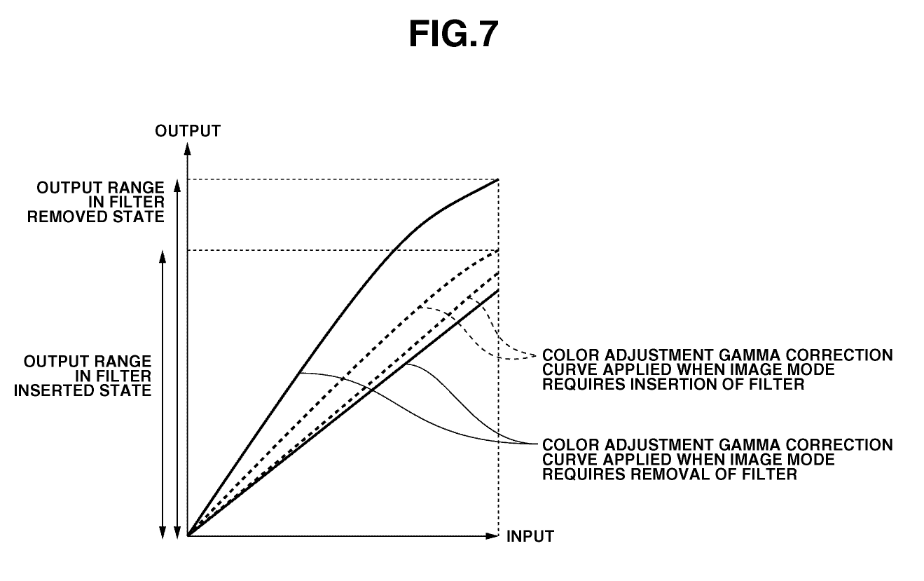

FIG. 7 illustrates gamma characteristics in each image mode.

As shown in FIG. 7, color adjustment gamma correction data can be switched depending on a selected image mode. The output range of respective color adjustment gamma correction circuits 21, 31, and 41, i.e., the input range of respective liquid crystal gamma correction circuits 22, 32, and 42, is variable depending on the image mode.

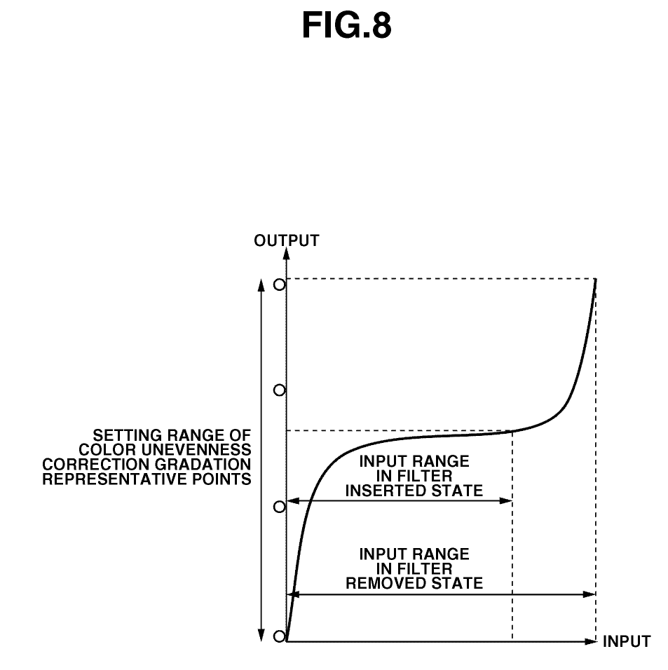

Accordingly, when the image mode requires switching the filter control and changing the color adjustment gamma correction data as described in the first exemplary embodiment (refer to FIGS. 5 and 6), the action state of the filter determines the input range of the liquid crystal gamma correction circuits 22, 32, and 42 as shown in FIG. 8.

When the input/output characteristics of the liquid crystal gamma correction circuits 22, 32, and 42 are unequivocal, insertion/removal of the filter determines the output range of respective liquid crystal gamma correction circuits 22, 32, and 42.

When the brightness is emphasized, the filter is removed. Thus, as shown in FIG. 8, the maximum panel reflectivity settable in a filter removed state tends to be lower compared to the reflectivity of any image mode in a filter inserted state.

If gradation representative points for the color unevenness correction control are without considering insertion/removal of the filter set as shown in FIG. 8, some of representative points are positioned in a gradation range not used when the filter is inserted.

In other words, vast correction data in the non-used gradation range are useless.

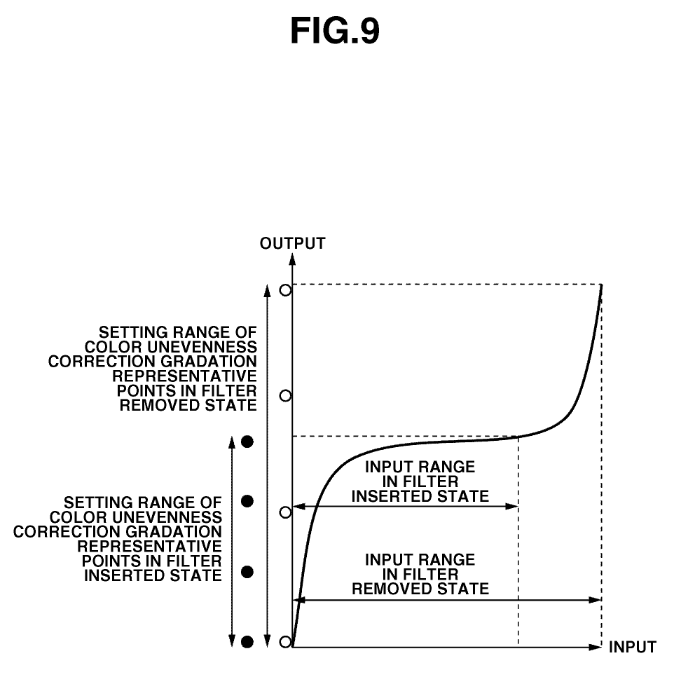

Hence, as shown in FIG. 9, gradation representative points are set considering the input gradation range variable depending on insertion/removal of the filter.

If the total number of gradation representative points is the same, the color unevenness can be more accurately corrected in a filter inserted state compared to a filter removed state.

When each input gradation range is sufficiently small in a filter inserted state, the total number of gradation representative points can be decreased if desirable to reduce the amount of correction data (i.e., a required memory capacity).

The above-described embodiment changes the gradation range. Selecting many of the representative points from a gradation range where the color unevenness greatly changes depending on the filter may be useful.

Furthermore, software program code for realizing the functions of the above-described exemplary embodiments can be supplied to a system or an apparatus connected to various devices. A computer (or CPU or micro-processing unit (MPU)) in the system or the apparatus can execute the program to operate the devices to realize the functions of the above-described exemplary embodiments. Accordingly, the present invention encompasses the program code installable in a computer when the functions or processes of the exemplary embodiments can be realized by the computer.

In this case, the program code itself can realize the functions of the exemplary embodiments. The equivalents of programs can be used if they possess comparable functions. Furthermore, the present invention encompasses the means for supplying the program code to a computer, such as a storage (or recording) medium storing the program code. In this case, the type of program can be any one of object code, interpreter program, and operating system (OS) script data. A storage medium supplying the program can be selected from any one of a flexible (floppy) disk, a hard disk, an optical disk, a magneto-optical (MO) disk, a compact disk—ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a home page on the Internet using the browsing function of a client computer, when the home page allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different home pages. Namely, the present invention encompasses world wide web (WWW) servers that allow numerous users to download the program files so that the functions or processes of the present invention can be realized on their computers.

Furthermore, enciphering the programs of the present invention and storing the enciphered programs on a CD-ROM or comparable recording medium is an exemplary method when the programs of the present invention are distributed to the users. The authorized users (i.e., users satisfying predetermined conditions) are allowed to download key information from a page on the Internet. The users can decipher the programs with the obtained key information and can install the programs on their computers. When the computer reads and executes the installed programs, the functions of the above-described exemplary embodiments can be realized.

Furthermore, an OS or other application software running on the computer can execute part or all of the actual processing based on instructions of the programs.

Furthermore, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2006-032501 filed Feb. 9, 2006, which is hereby incorporated by reference herein in its entirety.

What is claimed is:

1. A projection display apparatus comprising:
a plurality of display units;
a control unit configured to control images generated by the plurality of display units;
an optical filter configured to be inserted to and removed from an optical path; and
a storage unit configured to store plural kinds of correction data for each display unit so that correction data can be selected depending on insertion/removal of the optical filter,
wherein the control unit is configured to select specific data from the plural kinds of correction data, for each display unit, depending on insertion/removal of the optical filter and to control each display unit based on the selected data.

2. The projection display apparatus according to claim 1, wherein the plural kinds of correction data for each display unit are correction values of a plurality of representative points, and wherein the control unit is configured to obtain required correction values based on interpolation calculation using the correction values of the representative points.

3. The projection display apparatus according to claim 1, further comprising a light source adapted to supply light to illuminate the plurality of display units, wherein the optical filter is inserted to and removed from the optical path between the light source and the plurality of display units.

4. A projection display apparatus comprising:
a plurality of display units;
a control unit configured to control images generated by the plurality of display units;
a storage unit configured to store plural kinds of color unevenness correction data for each display unit so that correction data can be selected depending on a display mode,
wherein the control unit is configured to select specific data from the plural kinds of correction data, for each display unit, depending on the display mode and to control each display unit based on the selected data.

5. A method for controlling a projection display apparatus comprising a plurality of display units, an optical filter configured to be inserted to and removed from an optical path, and a storage unit configured to store plural kinds of correction data for each display unit, the method comprising:
selecting specific data from the plural kinds of correction data, for each display unit, depending on insertion/removal of the optical filter; and
controlling each display unit based on the selected data.

6. A method for controlling a projection display apparatus comprising a plurality of display units and a storage unit configured to store plural kinds of color unevenness correction data for each display unit, the method comprising:
selecting specific data from the plural kinds of correction data, for each display unit, depending on a display mode; and
controlling each display unit based on the selected data.

7. A storage medium for storing program code readable and executable by a computer for controlling a projection display apparatus comprising a plurality of display units, an optical filter configured to be inserted to and removed from an optical path, and a storage unit configured to store plural kinds of correction data for each display unit, the program code comprising:
computer-executable instructions for selecting specific data from the plural kinds of correction data, for each display unit, depending on insertion/removal of the optical filter; and
computer-executable instructions for controlling each display unit based on the selected data.

8. A storage medium for storing program code readable and executable by a computer for controlling a projection display apparatus comprising a plurality of display units and a storage unit configured to store plural kinds of color unevenness correction data for each display unit, the program code comprising:
computer-executable instructions for selecting specific data from the plural kinds of correction data, for each display unit, depending on a display mode; and
computer-executable instructions for controlling each display unit based on the selected data.
